(19) United States
(12) Patent Application Publication
(10) Pub. No.: US 2012/0187617 A1
(43) Pub. Date: Jul. 26, 2012

(54) FINGER PINCH PREVENTING HAND-HELD QUICK-CLAMPING DEVICE

(75) Inventor: Tzu-Chi Kuo, Keelung City (TW)

(73) Assignee: SHENG PU PROMOTION CO., LTD., Xinbei City (TW)

(21) Appl. No.: 13/011,869

(22) Filed: Jan. 22, 2011

(51) Int. Cl. B25B 5/06

(52) U.S. Cl. 269/6

(57) ABSTRACT

A finger pinch preventing hand-held quick-clamping device includes a shifting lever, a fixed handle, a drive handle, a jaw holder, a first jaw affixed to the jaw holder, a second jaw affixed to the fixed handle, a movable stop block set in the fixed handle and a release lever having a triggering tip adapted for moving the movable stop block into stoppage against the drive handle to keep a predetermined gap between the drive handle and the fixed handle and to prevent finger pinch when the release lever is biased to release the workpiece.

### BACKGROUND OF THE INVENTION

(a) Field of the Invention

The present invention relates to a hand-held quick-clamping device and more particularly to a finger pinch preventing hand-held quick-clamping device, which prevents finger pinch when the drive handle jumps back when the clamping is released.

(b) Description of the Prior Art

Many quick-clamping tools are commercially available for clamping or expanding a workpiece. U.S. Pat. No. 7,513,492 (application Ser. No. 12/051,848) discloses a hand held quick-clamping device issued to the present applicant. This design of hand held quick-clamping device includes an adjusting rod, a retaining handle, a driving handle, a first clamping block, and a second clamping block. Through a top shaft, an axial shaft pushes certain adjusting sheets and stop sheets. And the movement of the sheets will drive the adjusting rod to move in one direction, thus producing a clamping or extending function. This design of the hand held quick-clamping device is functional, however the user's fingers may be pinched by the retaining handle and the driving handle when the operator releases the hand held quick-clamping device from the clamping or extending position.

### SUMMARY OF THE INVENTION

The present invention has been accomplished under the circumstances in view. It is therefore an object of the present invention to provide a finger pinch preventing hand-held quick-clamping device, which prevents finger pinch when the drive handle jumps back after the workpiece is released.

To achieve this and other objects of the present invention, a finger pinch preventing hand-held quick-clamping device, comprising: a shifting lever, a fixed handle, a drive handle and a jaw holder, the shifting lever being affixed to the jaw holder and inserted through the fixed handle, the jaw holder holding a first jaw at one end thereof remote from the shifting lever, the fixed handle holding a second jaw at one end thereof corresponding to the first jaw, the drive handle being pivotally connected to the fixed handle and operable to move the shifting lever, the fixed handle having a release lever pivotally connected thereto, the release lever being biasable to release the finger pinch preventing hand-held quick-clamping device, wherein at least one movable stop block is set in the fixed handle; the release lever comprises a triggering tip adapted for moving the at least one movable stop block into stoppage against the drive handle to keep a predetermined gap between the drive handle and the fixed handle when the release lever is biased to release the finger pinch preventing hand-held quick-clamping device.

Further, the drive handle comprises a butt protruding from an inner side thereof for stopping against the at least one movable stop block.

Further, the triggering tip extends from one end of the release lever. Further, the triggering tip can be formed integral with one end of the release lever and capped with an end piece.

Further, each movable stop block has a beveled face located on one side thereof and kept in contact with the triggering tip.

In one embodiment of the invention, only one single movable stop block is used. In an alternate form of the invention, two movable stop blocks are set in the fixed handle at two opposite sides relative to the triggering tip of the release lever.

Further, a return spring is provided for automatically returning the at least one movable stop block back to its former position after each clamping operation. Further, the return spring can be a spring wire rod, torsion spring or compression spring connected between the at least one movable stop block and the fixed handle.

### BRIEF DESCRIPTION OF THE DRAWINGS

FIG. 1 is an elevational assembly view of a finger pinch preventing hand-held quick-clamping device in accordance with the present invention.

FIG. 2 is an exploded view of the finger pinch preventing hand-held quick-clamping device in accordance with the present invention.

FIG. 3 is a sectional view of the finger pinch preventing hand-held quick-clamping device in accordance with the present invention.

FIG. 4 corresponds to FIG. 3, illustrating the drive handle being pressed.

FIG. 5 is a sectional elevation, in an enlarged scale, of a part of the present invention, illustrating the relationship between the movable stop block and the release lever.

FIG. 6 corresponds to FIG. 5, illustrating the release lever being biased.

FIG. 7 is a schematic sectional view of the present invention, illustrating the movable stop block stopped against the drive handle.

FIG. 8 is a schematic sectional view of an alternate form of the finger pinch preventing hand-held quick-clamping device in accordance with the present invention.

FIG. 9 is a schematic sectional elevational view of a part of another alternate form of the finger pinch preventing hand-held quick-clamping device in accordance with the present invention.

FIG. 10 corresponds to FIG. 9, illustrating the release lever being biased.

### DETAILED DESCRIPTION OF THE PREFERRED EMBODIMENTS

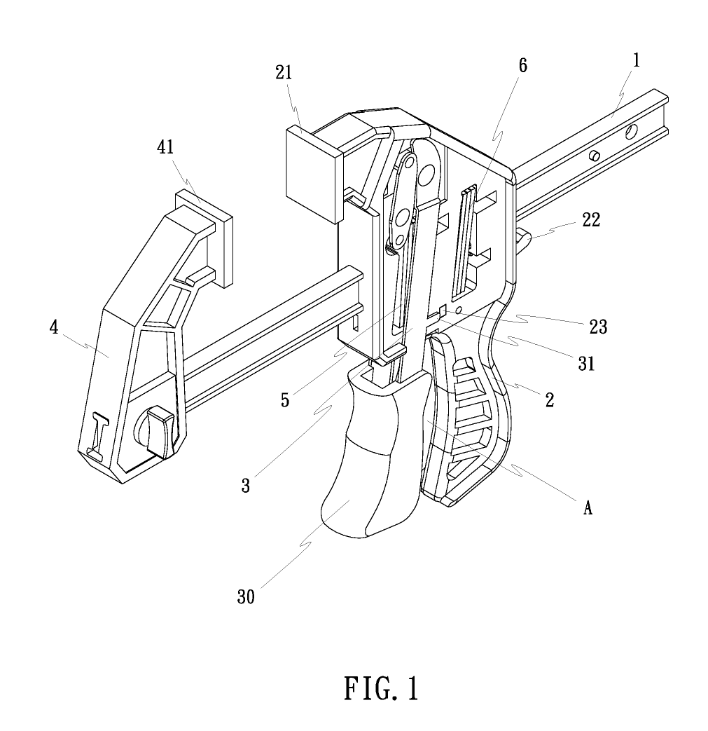

As illustrated in FIGS. 1˜4, a finger pinch preventing hand-held quick-clamping device in accordance with the present invention comprises a shifting lever 1, a fixed handle 2, a drive handle 3, and a jaw holder 4.

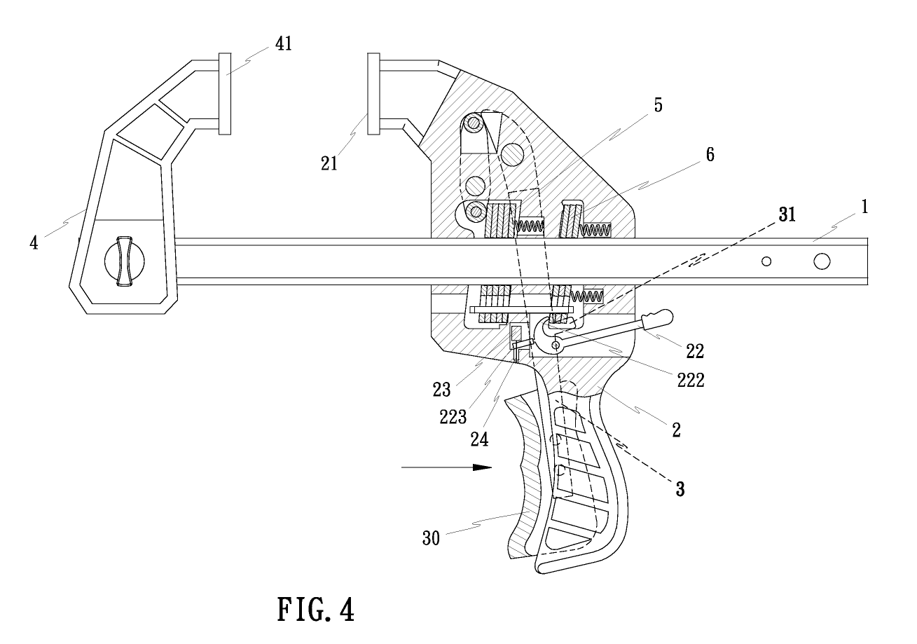

The shifting lever 1 is affixed to the jaw holder 4 and inserted through the fixed handle 2. A first jaw 41 is fixedly arranged on one end of the jaw holder 4 remote from the shifting lever 1. A second jaw 21 is fixedly arranged on one end of the fixed handle 2 corresponding to the first jaw 41 at the jaw holder 4. The drive handle 3 is pivotally connected to the fixed handle 2, having a grip 30 located on its one end (the bottom end) remote from the fixed handle 2. The drive handle 3 is operable to move actuating plates 5 and stop plates 6 in the fixed handle 2. When the drive handle 3 is pressed (see FIG. 4), the actuating plates 5 are forced to move the shifting lever 1 in one direction relative to the fixed handle 2, thereby causing the first jaw 41 to be moved toward the second jaw 21 to clamp the workpiece, or apart from the second jaw 21 to release the workpiece. Further, a release lever 22 is pivotally connected to the fixed handle 2. When the finger pinch preventing hand-held quick-clamping device is in an actuated status (clamping or expanded status), certain spring power is preserved in the quick-clamping device due to the pressing of the drive handle 3. The user can operate the release lever 22 to release the stored spring power of the quick-clamping device, thereby loosening the actuating plates 5 and the stop plates 6 from the shifting lever 1. As the aforesaid composition is of the known art, no further detailed description in this regard is necessary.

The improvement by the invention will be described hereinafter. The release lever 22 comprises an arched push block 222 and a triggering tip 221. A movable stop block 23 is set in the fixed handle 2. When the release lever 22 is biased to release the stored spring power of the quick-clamping device, the arched front block 222 will be forced to move the stop plates 6 out of the engagement position, and the triggering tip 221 will be synchronously forced to move the movable stop block 23 into engagement with the drive handle 3, stopping the drive handle 3 (or the grip 30 of the drive handle 3) from touching the fixed handle 2. Therefore, the invention prevents a finger pinch when the drive handle 3 jumps back after each clamping operation.

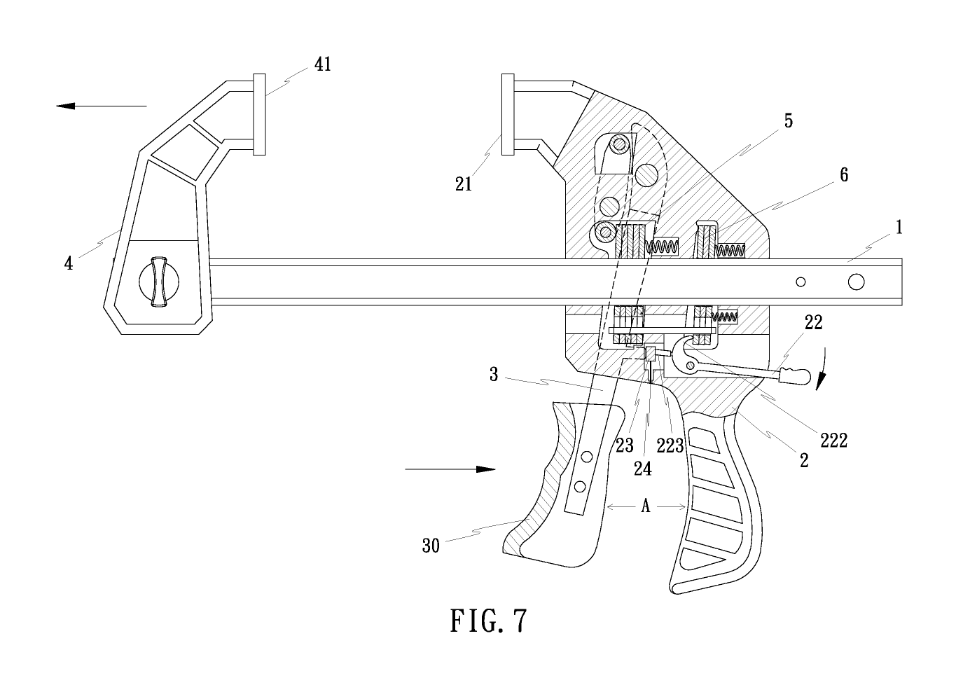

In the above-stated first embodiment, the drive handle 3 comprises a butt 31 for stopping against the movable stop block 23 so that a gap A will be kept in between the fixed handle 2 and the drive handle 3 (or the grip 30 of the drive handle 3) when the drive handle 3 jumps back to release the stored spring power of the quick-clamping device (se FIG. 7), preventing accidental finger injury.

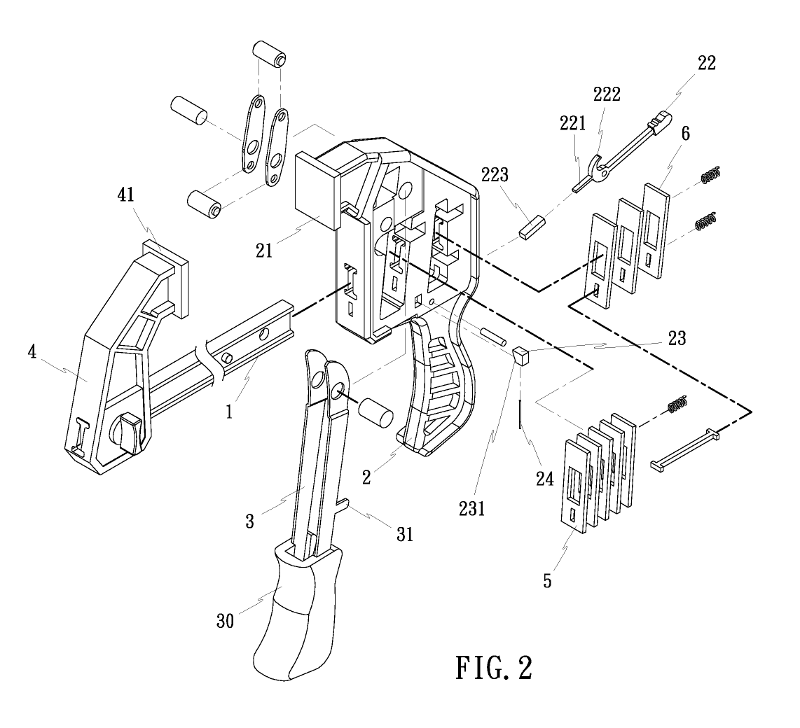

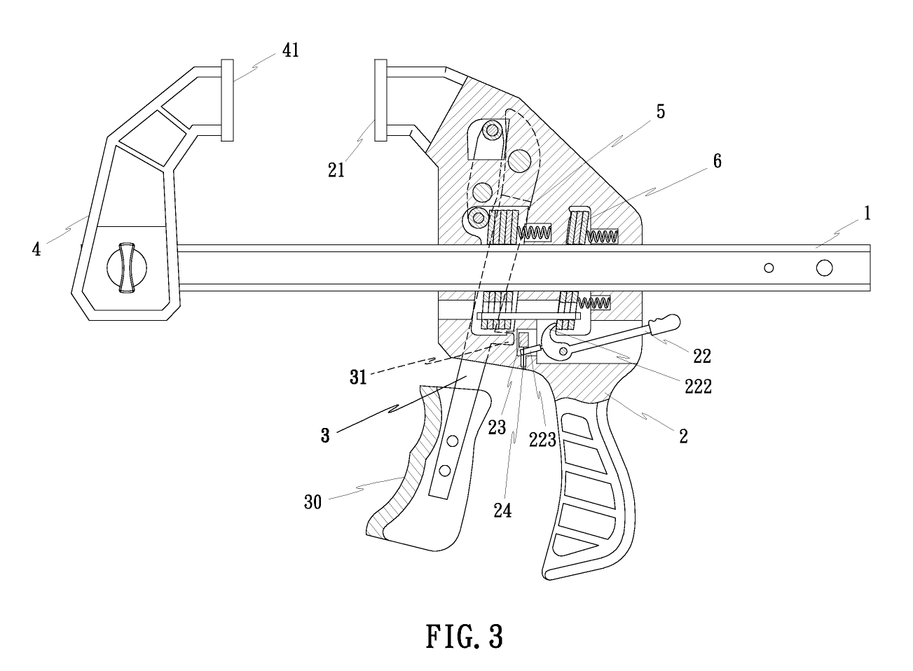

As illustrated in FIG. 2, the arched push block 222 is located on the front end of the release lever 22; the triggering tip 221 extends forwardly from the front side of the arched front block 222. Further, an end piece 223 may be capped on the triggering tip 221 (see FIG. 2). When the release lever 22 is biased to force the arched front block 222 in moving the stop plates 6 out of the engagement position, the triggering tip 221 or the end piece 223 will be synchronously forced to move the movable stop block 23 into stoppage against the drive handle 3 or the butt 31 of the drive handle 3, stopping the drive handle 3 (or the grip 30 of the drive handle 3) (see FIG. 1 or FIG. 7), prohibiting the drive handle 3 (or the grip 30 of the drive handle 3) from impacting the fixed handle 2 and preventing accidental finger injury when the drive handle 3 jumps back to release the stored spring power of the quick-clamping device.

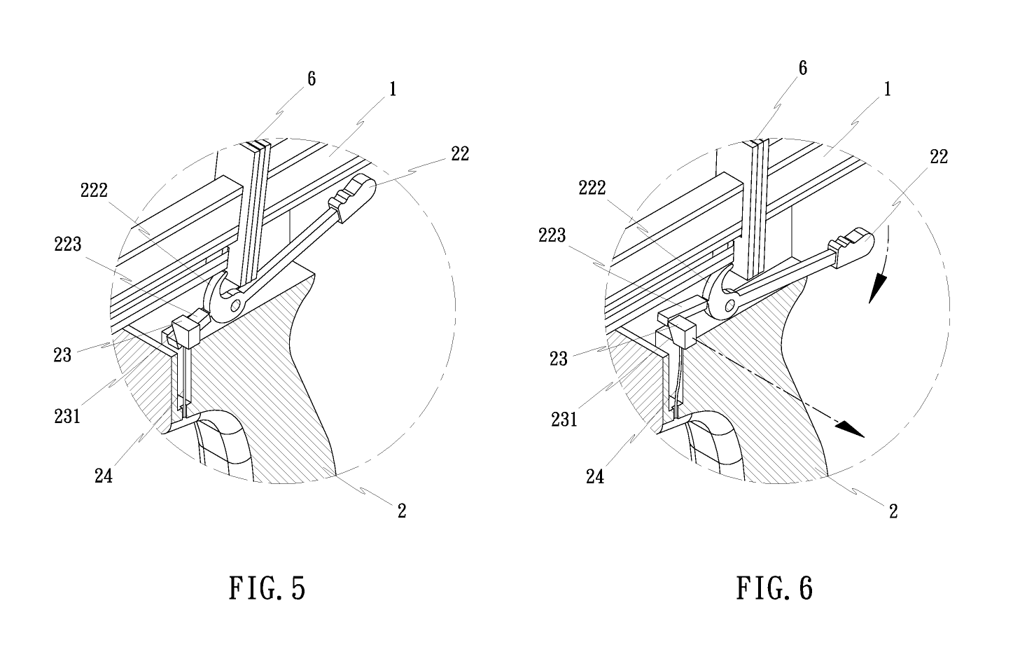

As shown in FIG. 5 and FIG. 6, the movable stop block 23 has a beveled face 231 located on its one lateral side for contacting the end piece 223 at the triggering tip 221 of the release lever 22 (it is to be understood that the end piece 223 is simply an optional member but not a requisite). Normally, the end piece 223 (or the triggering tip 221) of the release lever 22 is stopped at the bottom side of the beveled face 231 of the movable stop block 23 (see FIG. 5). When the user biases the release lever 22, the end piece 223 (or the triggering tip 221) of the release lever 22 will be moved upwardly along the beveled face 231 of the movable stop block 23, causing the movable stop block 23 to displace outwards (see FIG. 6). When the movable stop block 23 is forced to displace outwards, it will be stopped against the butt 31 of the drive handle 3 (see FIG. 7), therefore a gap A can be kept in between the fixed handle 2 and the drive handle 3, preventing a finger pinch.

Further, as shown in FIG. 5 and FIG. 6, the movable stop block 23 is supported on a return spring 24. The return spring 24 is a spring wire rod, having its one end connected to the movable stop block 23 and its other end connected to the fixed handle 2. Due to the functioning of the return spring 24, the movable stop block 23 will be automatically returned to its former position by the return spring 24 after each operation of the release lever 22.

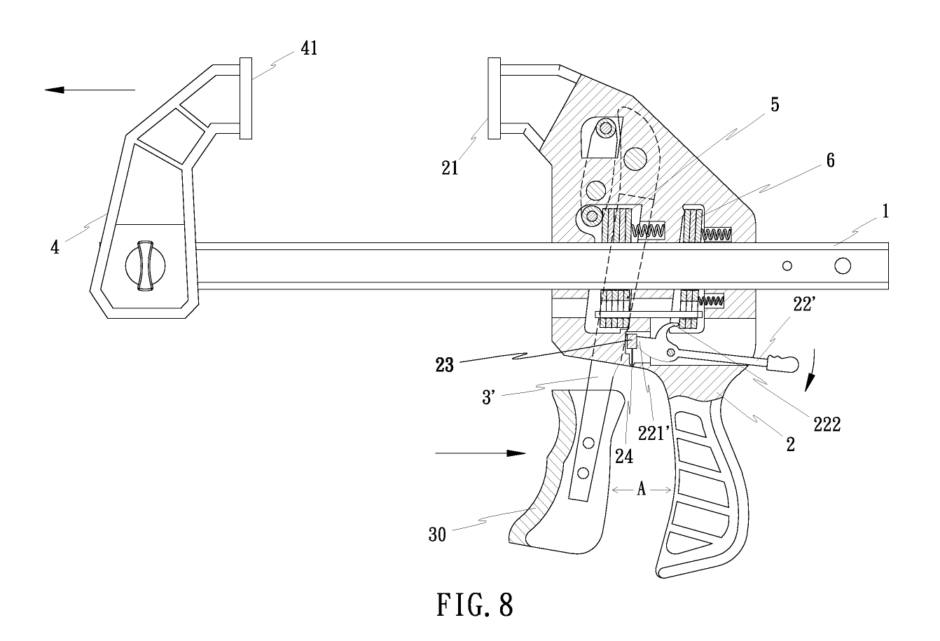

FIG. 8 illustrates an alternate form of the present invention. According to this alternate form, the triggering tip 221′ is integrally formed with the front end of the release lever 22′. Further, the triggering tip 221 or 221′ can be made in any of a variety of shapes capable of moving the movable stop block 23. Further, the drive handle 3′ of this alternate form eliminates the aforesaid butt 31, and is stoppable with its inner side edge against the movable stop block 23 to leave a gap A in between the fixed handle 2 and the drive handle 3′, thus preventing a finger pinch.

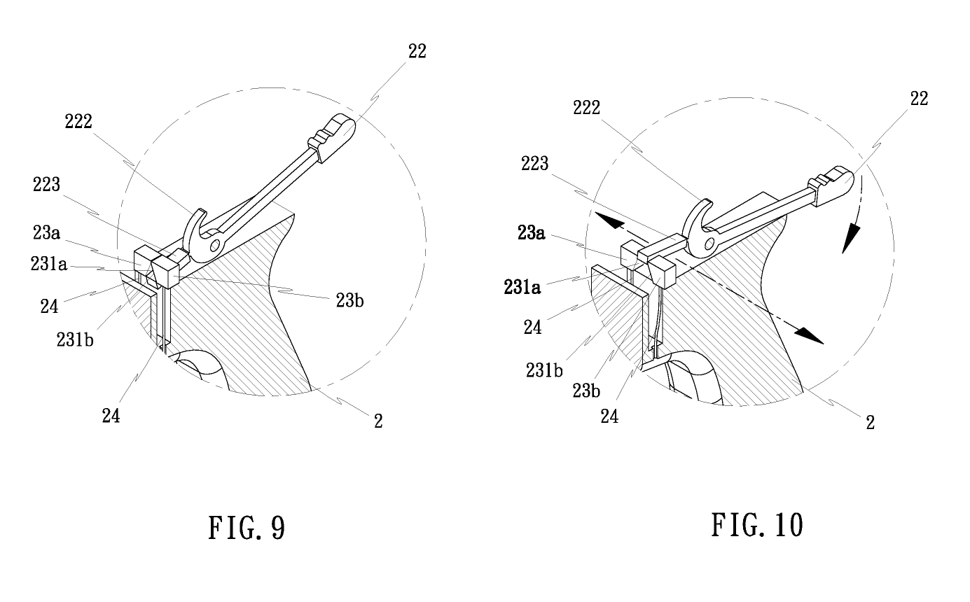

FIG. 9 illustrates another alternate form of the present invention. According to this alternate form, two movable stop blocks 23a; 23b are set in the fixed handle 2 at two opposite sides relative to the end piece 223 at the triggering tip 221 of the release lever 22. When the user biases the release lever 22, the triggering tip 221 or the end piece 223 will be forced to move the two movable stop blocks 23a; 23b bilaterally outwards into stoppage against the drive handle 3 (see FIG. 10), prohibiting the drive handle 3 from impacting the fixed handle 2 and preventing accidental finger injury.

Although particular embodiments of the invention have been described in detail for purposes of illustration, various modifications and enhancements may be made without departing from the spirit and scope of the invention. For example, the return spring 24 can be a torsion spring or a compression spring instead of the aforesaid spring wire rod. Accordingly, the invention is not to be limited except as by the appended claims.

What is claimed is:

1. A finger pinch preventing hand-held quick-clamping device, comprising: a shifting lever, a fixed handle, a drive handle and a jaw holder, said shifting lever being affixed to said jaw holder and inserted through said fixed handle, said jaw holder holding a first jaw at one end thereof remote from said shifting lever, said fixed handle holding a second jaw at one end thereof corresponding to said first jaw, said drive handle being pivotally connected to said fixed handle and operable to move said shifting lever, said fixed handle having a release lever pivotally connected thereto, said release lever being biasable to release the finger pinch preventing hand-held quick-clamping device, wherein:
at least one movable stop block is set in said fixed handle;
said release lever comprises a triggering tip adapted for moving said at least one movable stop block into stoppage against said drive handle to keep a predetermined gap between said drive handle and said fixed handle when said release lever is biased to release the finger pinch preventing hand-held quick-clamping device.

2. The finger pinch preventing hand-held quick-clamping device as claimed in claim 1, wherein said drive handle comprises a butt protruding from an inner side thereof for stopping against said at least one movable stop block.

3. The finger pinch preventing hand-held quick-clamping device as claimed in claim 1, wherein said triggering tip extends from one end of said release lever.

4. The finger pinch preventing hand-held quick-clamping device as claimed in claim 1, further comprising an end piece fixedly capped on said triggering tip.

5. The finger pinch preventing hand-held quick-clamping device as claimed in claim 1, wherein each said movable stop block has a beveled face located on one side thereof and kept in contact with said triggering tip.

6. The finger pinch preventing hand-held quick-clamping device as claimed in claim 1, wherein said at least one movable stop block is loaded with a return spring.

7. The finger pinch preventing hand-held quick-clamping device as claimed in claim 6, wherein said return spring is a spring wire rod connected between said at least one movable stop block and said fixed handle.

8. The finger pinch preventing hand-held quick-clamping device as claimed in claim 1, wherein said triggering tip is integrally formed with one end of said release lever.

9. The finger pinch preventing hand-held quick-clamping device as claimed in claim 6, wherein the number of said at least one movable stop block is 2, and the two movable stop blocks are set in said fixed handle at two opposite sides relative to said triggering tip of said release lever.

10. The finger pinch preventing hand-held quick-clamping device as claimed in claim 9, wherein each said movable stop block has a beveled face located on one side thereof and kept in contact with said triggering tip.
